(19) United States
(12) Patent Application Publication
(10) Pub. No.: US 2026/0005440 A1
(43) Pub. Date: Jan. 1, 2026

(54) ANTENNA WITH EXTENDED RESONATOR STRUCTURE

(71) Applicant: MEDIATEK INC., Hsinchu City (TW)

(72) Inventor: Nai-Chen Liu, Hsinchu City (TW)

(73) Assignee: MEDIATEK INC., Hsinchu City (TW)

(21) Appl. No.: 19/248,408

(22) Filed: Jun. 24, 2025

Related U.S. Application Data
(60) Provisional application No. 63/666,329, filed on Jul. 1, 2024.

(51) Int. Cl. H01Q 9/04; H01Q 1/48

(52) U.S. Cl. CPC H01Q 9/0407; H01Q 1/48

(57) ABSTRACT

An antenna includes a ground plane, a basic resonator disposed over the ground plane, and an extended resonator disposed over the ground plane and separated from the basic resonator by a first trench. The extended resonator comprises an extended plate, a coupler, at least one extended via, and at least one ground via. The coupler includes a coupler pad and a ground pad. The coupler pad and the ground pad are capacitively coupled. The at least one extended via is configured to electrically connect the extended plate to the coupler pad. The at least one ground via is configured to electrically connect the ground pad to the ground plane.

### CROSS REFERENCE TO RELATED APPLICATIONS

This application claims the benefit of U.S. Provisional Application No. 63/666,329, filed on Jul. 1, 2024. The content of the application is incorporated herein by reference.

### BACKGROUND

Modern wireless communication systems, such as 5G and Wi-Fi, continually demand higher data rates and more reliable performance. In increasingly crowded radio-frequency (RF) environments, antennas are often susceptible to out-of-band interference, which can degrade communication quality. Conventionally, discrete filter components are added to an RF front-end to suppress such interference. However, these additional filters can increase the overall circuit size, complexity, and cost, and may introduce undesirable signal loss.

Furthermore, conventional antenna architectures often consist of a simple structure such as a basic resonator. While functional, such structures may exhibit performance limitations. For example, many conventional antenna designs exhibit a relatively narrow radiation beam width, limiting their effective signal coverage. For mobile applications or access points intended to serve a wide area, the narrow beam width can result in inconsistent connectivity or signal dead zones.

Therefore, an improved antenna structure is required to provide both integrated filtering capabilities and a broad radiation beam width in a compact and efficient structure.

### SUMMARY

In an embodiment, an antenna comprises a ground plane, a basic resonator disposed over the ground plane, and an extended resonator disposed over the ground plane and separated from the basic resonator by a first trench. The extended resonator comprises an extended plate, a coupler, at least one extended via, and at least one ground via. The coupler comprises a coupler pad and a ground pad. The coupler pad and the ground pad are capacitively coupled. The at least one extended via is configured to electrically connect the extended plate to the coupler pad. The at least one ground via is configured to electrically connect the ground pad to the ground plane.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic perspective view of an antenna according to an embodiment of the present invention.

FIG. 2 is a schematic cross-sectional view of the antenna taken along line A of FIG. 1.

FIG. 3 is a schematic top view of an antenna according to another embodiment of the present invention.

FIG. 4 is a schematic top view of an antenna according to another embodiment of the present invention.

FIG. 5 is a schematic top view of an antenna according to another embodiment of the present invention.

FIG. 6 is a schematic top view of an antenna according to another embodiment of the present invention.

FIG. 7 is a schematic top view of an antenna according to another embodiment of the present invention.

FIG. 8 is a schematic cross-sectional view of the antenna taken along line A of FIG. 1 according to another embodiment.

FIG. 9 is a schematic cross-sectional view of the antenna taken along line A of FIG. 1 according to another embodiment.

FIG. 10 is a schematic cross-sectional view of the antenna taken along line A of FIG. 1 according to another embodiment.

FIG. 11 is a schematic cross-sectional view of the antenna taken along line A of FIG. 1 according to another embodiment.

### DETAILED DESCRIPTION

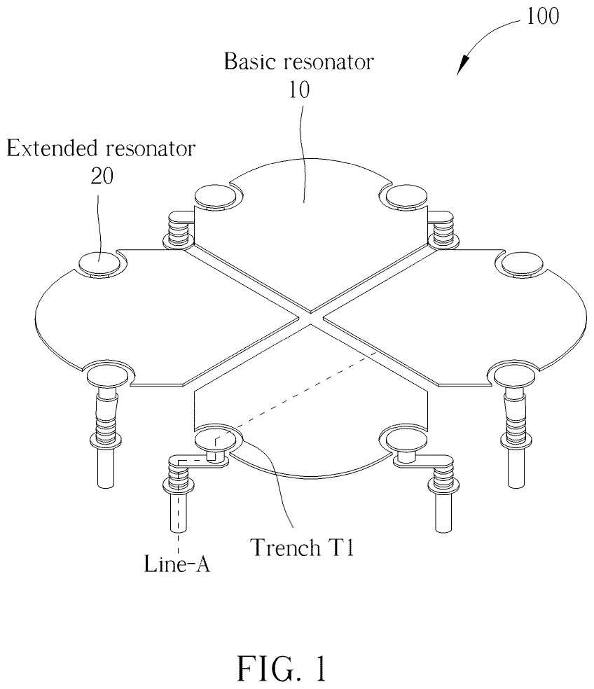

FIG. 1 is a schematic perspective view of an antenna 100 according to an embodiment of the present invention. As shown in FIG. 1, the antenna 100 includes a basic resonator 10 and a plurality of extended resonators 20. In this embodiment, the basic resonator 10 is centrally located, and the extended resonators 20 are disposed around the periphery of the basic resonator 10. Each extended resonator 20 is separated from the basic resonator 10 by a trench T1, which provides physical and electrical isolation on the plane of the resonator plates. It should be understood that FIG. 1 illustrates an exemplary embodiment, and the scope of the present invention is not limited thereto. For example, the number of extended resonators 20 is not limited to the four shown in the figure. In other embodiments, the antenna 100 may include a single extended resonator 20 or any other suitable number. Furthermore, the shape of the extended resonator 20 and the basic resonator 10 can be any suitable geometric shape and is not limited to the specific configuration illustrated. FIG. 1 is provided for illustrative purposes and should not be construed as limiting.

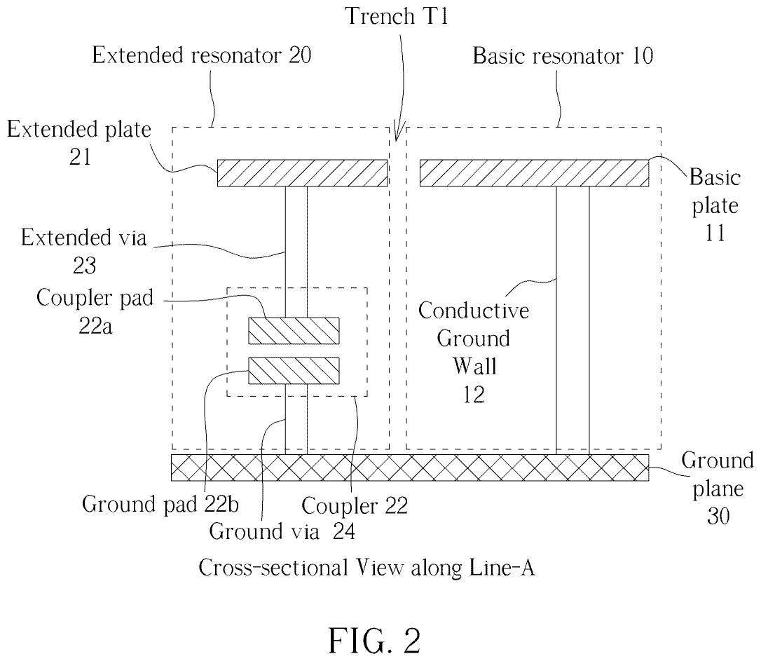

FIG. 2 is a schematic cross-sectional view of the antenna taken along line A of FIG. 1. As illustrated in FIG. 2, the antenna 100 further includes a ground plane 30. The ground plane 30 provides a common ground reference for the antenna structure and may also function as a reflector to direct radiation in a desired direction (e.g., in the Z direction). The basic resonator 10 disposed over the ground plane 30 includes a basic plate 11 and a conductive ground wall 12. The basic plate 11 can be regarded as a main radiating element, and its dimensions are a factor in determining the fundamental operating frequency of the antenna 100. The conductive ground wall 12 electrically connects the basic plate 11 to the ground plane 30, thereby establishing a ground path for the basic resonator 10.

The extended resonator 20 is configured to introduce filtering properties and enhance the beam width of the antenna 100. The extended resonator 20 includes an extended plate 21, an extended via 23, a coupler 22, and a ground via 24. The extended plate 21 acts as a parasitic radiating element that couples electromagnetically with the basic plate 11 across the trench T1. The coupler 22 includes a coupler pad 22a and a ground pad 22b. The coupler pad 22a and the ground pad 22b are vertically spaced to form a capacitor, and their capacitive coupling is a critical part of the filtering response of the extended resonator 20. The capacitance can be tuned by adjusting the area, shape, or separation distance of the coupler pad 22a and the ground pad 22b. Furthermore, in one embodiment, the coupler pad 22a is formed of a first conductive material. The ground pad 22b is formed of a second conductive material different from the first conductive material.

The extended via 23 provides an electrical path from the extended plate 21 to the coupler pad 22a, contributing to the inductive characteristics of the extended resonator 20. The ground via 24 provides a corresponding ground path from the ground pad 22b to the ground plane 30, completing the resonant circuit. The arrangement of the extended resonator 20 effectively forms an integrated Inductor-Capacitor (LC) resonant circuit coupled to the basic resonator 10, which allows for precise control over the antenna's frequency response and radiation pattern.

It should be understood that the conductive components described herein, including the ground plane 30, the basic plate 11, the conductive ground wall 12, the extended plate 21, the various vias (e.g., 23, 24), and the various pads (e.g., 22a, 22b), are not limited to a specific type of metal. In various embodiments, these components may be formed of any suitable conductive material, such as copper, aluminum, silver, gold, other conductive alloys, or other conductive materials such as conductive polymers.

As noted above, the structures of the basic resonator 10 and the extended resonator 20 may be subject to various modifications. For illustrative purposes, several non-limiting embodiments detailing variations of the basic resonator 10 and the extended resonator 20 will be described below.

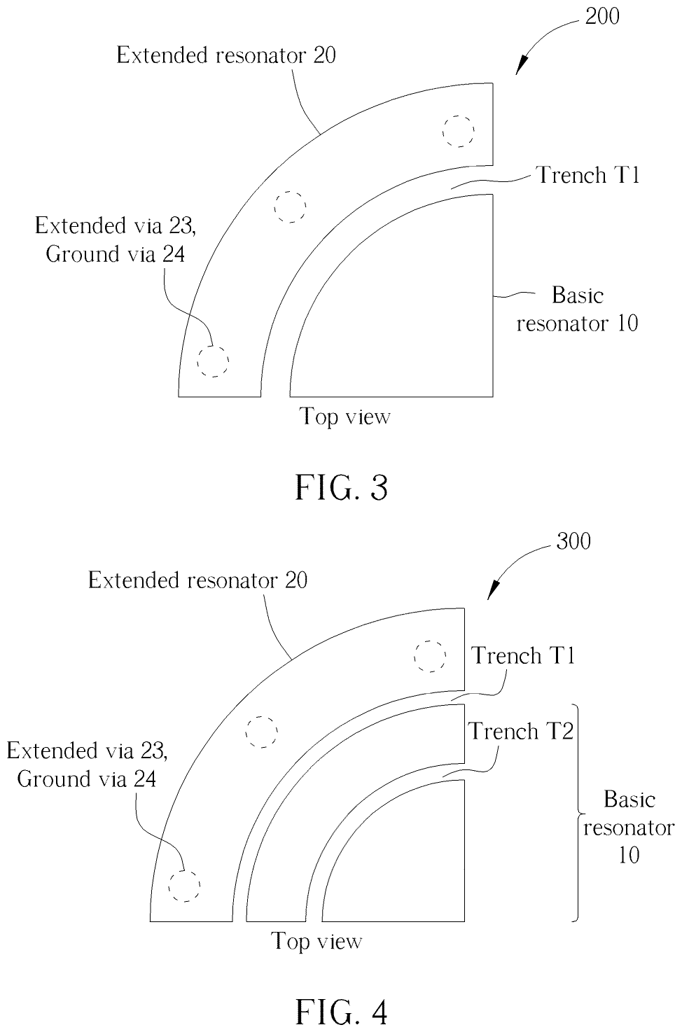

FIG. 3 is a schematic top view of the antenna 100 according to another embodiment of the present invention. The antenna 200 is a variation of the antenna 100 shown in FIG. 1 and illustrates that the shapes and arrangement of the resonators are not limited to the previously described configuration. In FIG. 3, a part of the basic resonator 10 of the antenna 200 includes a basic plate having the shape of a circular sector. The basic plate of the basic resonator 10 has a curved outer edge. The extended resonator 20 includes an extended plate that has a corresponding curved, arc-like shape. The extended plate of the extended resonator 20 is disposed adjacent to the curved edge of the basic resonator 10. The trench T1 is formed in the gap between the curved edge of the basic resonator 10 and an inner curved edge of the extended resonator 20.

Although not fully visible in the top view, it should be understood that the extended resonator 20 in this embodiment also includes the underlying structures as described with reference to FIG. 2, such as the extended via 23, the coupler 22, and the ground via 24, which connect the extended plate to the ground plane 30. The embodiment demonstrates the design flexibility of the antenna architecture while maintaining the core inventive concept of a basic resonator coupled with an extended resonator.

FIG. 4 is a schematic top view of an antenna according to another embodiment of the present invention. The antenna 300 can be regarded as a variation of the antenna 200 shown in FIG. 3, with a key modification to the basic resonator 10. The primary difference in the antenna 300 is that the basic resonator 10 is separated into a plurality of portions by a second trench, trench T2. In this embodiment, the trench T2 separates the basic plate of the basic resonator 10 into two distinct, concentric, arc-shaped conductive portions. The second trench T2 introduces additional capacitive and inductive effects, which can be used to further tune the resonant frequency and filtering characteristics of the antenna 300.

Similar to the embodiment of FIG. 3, the extended resonator 20 is disposed adjacent to the basic resonator 10 and is separated therefrom by the trench T1. It is also to be understood that the underlying via and coupler structures (e.g., extended via 23, coupler 22, and ground via 24) described in FIG. 2 are present in this embodiment as well.

In another embodiment, the structure of the antenna 300 may be further modified. The basic resonator 10, which is separated into a plurality of portions by the trench T2, may have its portions disposed on different layers. For example, the inner concentric, arc-shaped conductive portion may be disposed on a first layer, while the outer concentric, arc-shaped conductive portion may be disposed on a second layer different from the first layer. These portions on different layers may then be electrically connected by vias (not shown) or coupled electromagnetically, providing further means to engineer the antenna's performance characteristics. Any reasonable technology modification or hardware displacement falls into the scope of the present invention.

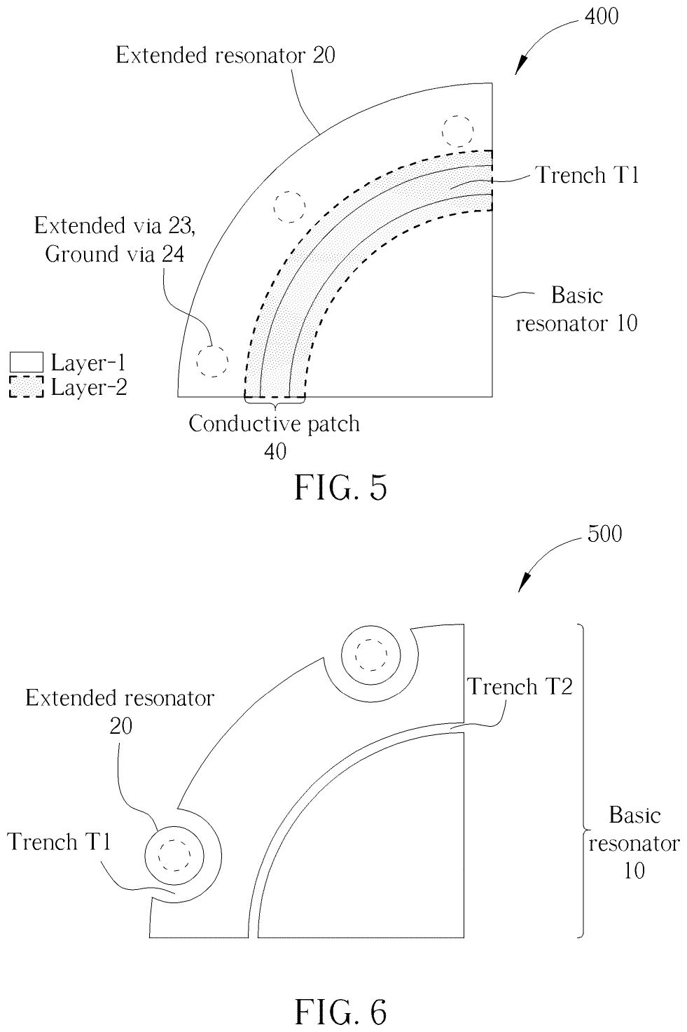

FIG. 5 is a schematic top view of an antenna 400 according to another embodiment of the present invention. The antenna 400 introduces a conductive patch 40, which is configured to enhance the capacitive coupling between the basic resonator 10 and the extended resonator 20. In this embodiment, the basic plate of the basic resonator 10 and the extended plate of the extended resonator 20 are disposed on a first layer (e.g., Layer-1 as indicated in the legend). The conductive patch 40 is disposed on a second layer (e.g., Layer-2) different from the first layer. As shown in FIG. 5, the conductive patch 40 is positioned generally under the trench T1 such that it at least partially overlaps with both the basic plate of the basic resonator 10 and the extended plate of the extended resonator 20. The overlapping arrangement creates an additional parallel-plate capacitance between the resonators, which can be used to further control the filtering characteristics and frequency response of the antenna.

It should be understood that other aspects of the antenna 400, such as the underlying via and coupler structures (e.g., extended via 23, coupler 22, ground via 24) are similar to those described in FIG. 2 and are also present in this embodiment.

In another embodiment, the antenna 400 shown in FIG. 5 can be modified to include an additional tuning feature. Specifically, in addition to the conductive patch 40, the basic plate of the basic resonator 10 may also be separated into a plurality of portions by a second trench (similar to the trench T2 shown in FIG. 4). It provides enhanced adjusting capability, wherein the conductive patch 40 influences the coupling capacitance between the resonators, while the second trench in the basic plate is configured to tune the basic resonator's own resonant frequency.

FIG. 6 is a schematic top view of an antenna 500 according to another embodiment of the present invention. In the embodiment of FIG. 6, the basic resonator 10 includes a basic plate having a cutout or a notch along its periphery. The extended resonator 20 is disposed within the cutout, creating an in-set or embedded configuration. The arrangement provides for strong, localized electromagnetic coupling between the two resonators in a space-efficient manner. The trench Tl is formed in the gap between the edge of the cutout of the basic resonator 10 and the extended resonator 20.

Furthermore, the basic plate of the basic resonator 10 is separated into a plurality of portions by a second trench, trench T2. The trench T2 introduces a discontinuity in the basic resonator 10, which can be precisely engineered to adjust its resonant frequency and impedance. The combination of the in-set placement (via the cutout and trench T1) and the internal trench T2 provides at least two degrees of freedom for tuning the antenna's performance. Similarly, it should be understood that the underlying via and coupler structures as described in FIG. 2 are also present in this embodiment to complete the extended resonator structure.

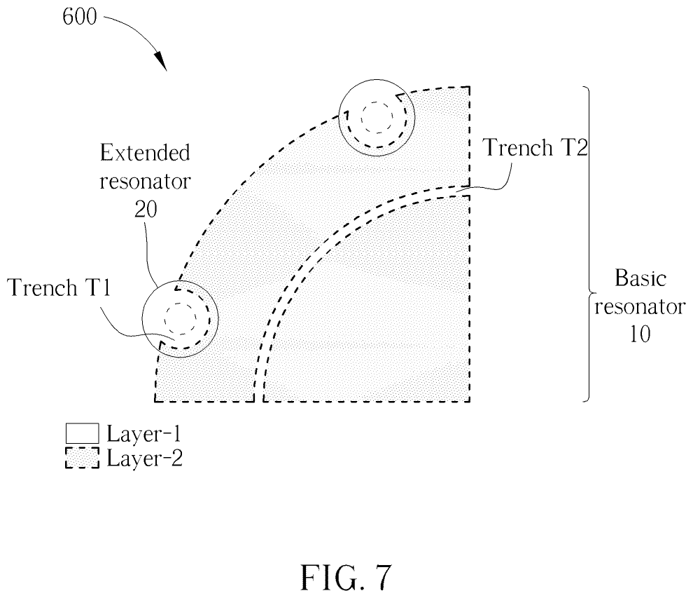

FIG. 7 is a schematic top view of an antenna 600 according to another embodiment of the present invention. The antenna 600 illustrates an embodiment that combines multiple features, including a specific geometric arrangement and a multi-layer structure. As shown in FIG. 7, the extended resonator 20 and the basic resonator 10 are disposed on different layers. Specifically, the extended plate of the extended resonator 20 is disposed on a first layer (e.g., Layer-1), while the basic plate of the basic resonator 10 is disposed on a second layer (e.g., Layer-2) different from the first layer.

In terms of geometric arrangement, the basic resonator 10 has a cutout, and the extended resonator 20 is positioned within the area defined by the cutout when viewed from the top. An advantage of this multi-layer arrangement is that the area of the extended plate is not limited by the area of the cutout. As the plates are on different layers, the extended plate can be designed to be larger than the cutout, which allows the extended plate to at least partially overlap the basic plate adjacent to the cutout. The vertical overlap can enhance the capacitive coupling between the extended resonator 20 and the basic resonator 10.

Furthermore, the basic plate of the basic resonator 10 is also separated into a plurality of portions by a second trench, trench T2. The multi-layer, embedded, and split configuration of the antenna 600 provides a high degree of design freedom. The vertical separation and overlap between the resonators provide for tuning interlayer capacitance, while the in-set geometry (via trench T1) controls lateral coupling, and the trench T2 adjusts the resonance of the basic resonator. Similarly, the underlying via and coupler structures as described in FIG. 2 are also present in this embodiment.

In addition to the various arrangements of the basic resonator 10 and the extended resonator 20 described above, the constituent components of the extended resonator 20 may also be subject to various modifications to achieve specific electrical characteristics. The following figures illustrate several embodiments of such detailed structural variations.

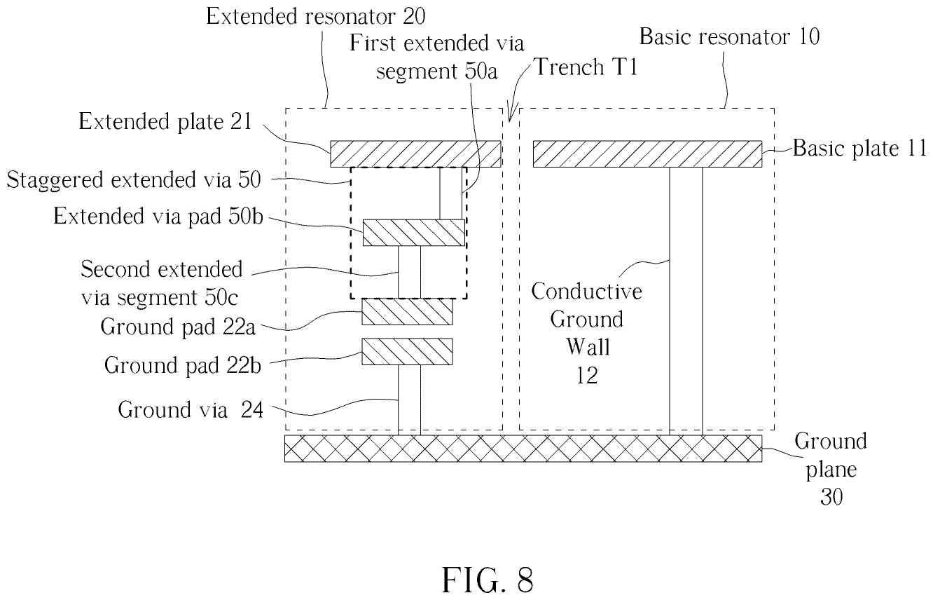

FIG. 8 is a schematic cross-sectional view of the antenna taken along line A of FIG. 1 according to another embodiment. The embodiment in FIG. 8 illustrates a staggered extended via 50, which is a specific implementation of the extended via 23 described in FIG. 2, and is configured to modify the inductive characteristics of the extended resonator 20 by elongating the electrical path.

As shown in FIG. 8, the staggered extended via 50 includes a first extended via segment 50a, an extended via pad 50b, and a second extended via segment 50c. The first extended via segment 50a extends downwards from the extended plate 21 to connect to the extended via pad 50b. The second extended via segment 50c extends downwards from the extended via pad 50b to connect to the coupler pad 22a. The first extended via segment 50a and the second extended via segment 50c are horizontally offset relative to each other. The extended via pad 50b provides the horizontal electrical connection between the first extended via segment 50a and the second extended via segment 50c. By introducing the staggered extended via 50, it can effectively increase the total length of the via structure, which can be used to precisely tune the inductance of the integrated Inductor-Capacitor (LC) resonant circuit.

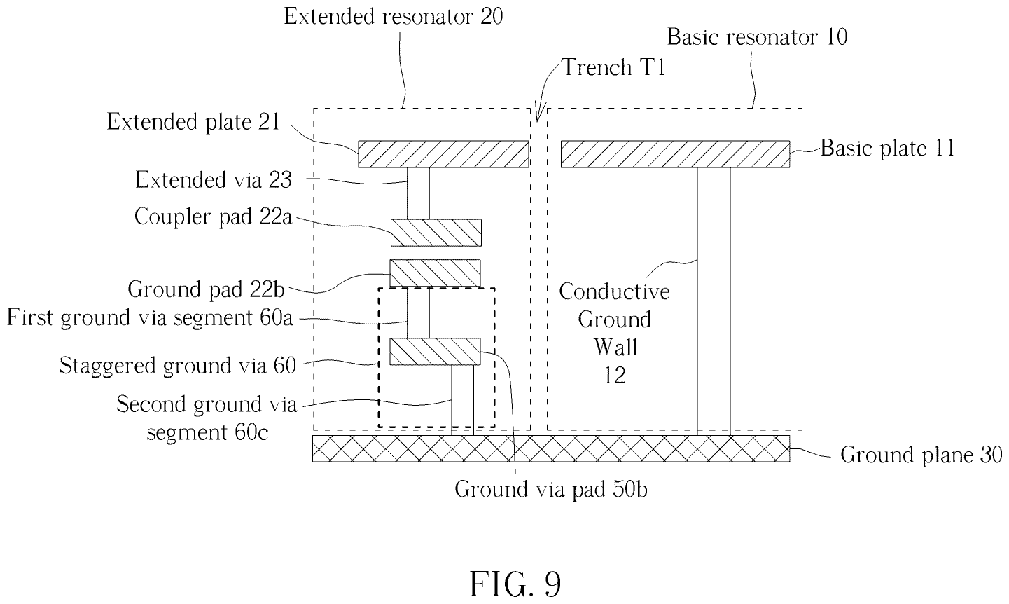

FIG. 9 is a schematic cross-sectional view of the antenna taken along line A of FIG. 1 according to another embodiment. The embodiment of FIG. 9 illustrates a staggered ground via 60. The staggered ground via 60 is a specific implementation of the ground via 24 described in FIG. 2 and is configured to modify the electrical characteristics of the extended resonator 20 by altering the inductance of the ground path.

As shown in FIG. 9, the staggered ground via 60 includes a first ground via segment 60a, a ground via pad 50b, and a second ground via segment 60c. The first ground via segment 60a extends downwards from the ground pad 22b to connect to the ground via pad 50b. The second ground via segment 60c extends downwards from the ground via pad 50b to connect to the ground plane 30. The first ground via segment 60a and the second ground via segment 60c are horizontally offset relative to each other. The ground via pad 50b provides the horizontal electrical connection between the first ground via segment 60a and the second ground via segment 60c. The “staggered ground via 60” configuration elongates the path to ground, used for further tuning of the resonant characteristics of the extended resonator 20.

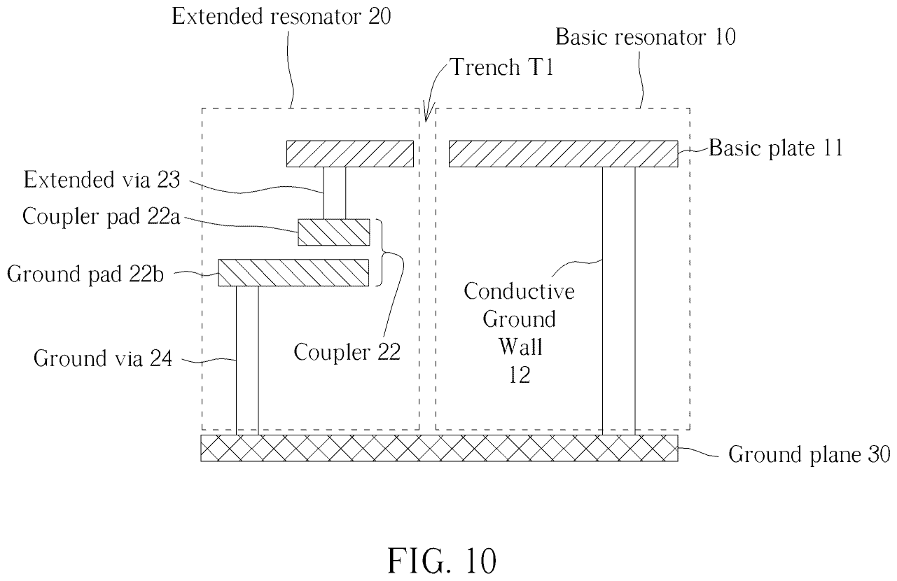

FIG. 10 is a schematic cross-sectional view of the antenna taken along line A of FIG. 1 according to another embodiment. The embodiment of FIG. 10 illustrates that the pads within the coupler 22 can have different shapes or sizes to tune the capacitive coupling. As shown in FIG. 10, the coupler 22 includes the coupler pad 22a and the ground pad 22b. In this embodiment, a shape of the ground pad 22b is different from a shape of the coupler pad 22a. For instance, the ground pad 22b is illustrated as having a larger width and therefore a larger surface area than the coupler pad 22a. By varying the shape, area, or dimensional ratio of the coupler pad 22a and the ground pad 22b, the resulting capacitance of the coupler 22 can be precisely controlled. The embodiment in FIG. 10 provides another degree of freedom for designing the filtering characteristics of the extended resonator 20.

Other components, such as the extended plate 21, the extended via 23, the ground via 24, and the basic resonator 10, may be similar to those described in the embodiment of FIG. 2. Therefore, details are omitted here.

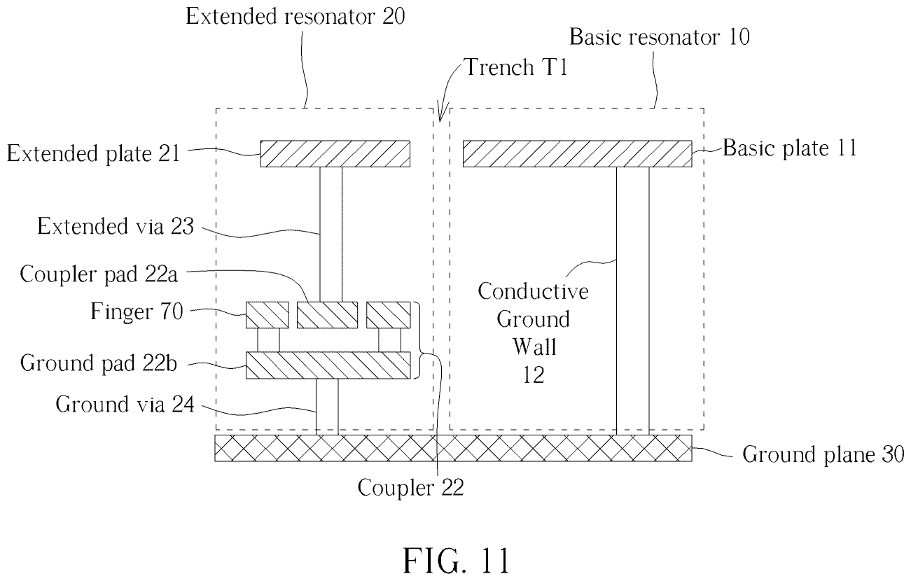

FIG. 11 is a schematic cross-sectional view of the antenna taken along line A of FIG. 1 according to another embodiment. The embodiment of FIG. 11 illustrates a coupler 22 having an interdigitated structure, which is configured to significantly enhance capacitive coupling between the coupler pad 22a and the ground pad 22b.

As shown in FIG. 11, the coupler pad 22a includes at least one first finger (not separately numbered in this view) extending downwards toward the ground pad 22b. Correspondingly, the ground pad 22b includes at least one second finger 70 extending upwards toward the coupler pad 22a. The at least one first finger and the at least one second finger 70 are interdigitated. It implies that they are interleaved in a comb-like structure without making direct electrical contact. In the embodiment, the number of fingers extending from each pad can be different, which results in the coupler pad 22a and the ground pad 22b having different shapes or sizes.

The advantage of the interdigitated structure of the coupler 22 is a significant increase in the effective surface area for capacitive coupling. In addition to the parallel-plate capacitance between the horizontal portions of the pads, this structure introduces strong lateral (side-to-side) fringing capacitance between the vertical surfaces of the interleaved fingers. The coupler 22 in FIG. 11 can enhance capacitance for a greater range of filter tuning, or alternatively, allow for achieving a target capacitance within a smaller physical footprint compared to a simple parallel-plate capacitor.

The architecture of the antenna in the embodiments, including both the basic resonator 10 and the coupled extended resonator 20, provides significant performance advantages over conventional antenna designs. One significant advantage is improved out-band radiation suppression. The extended resonator 20 is regarded as an integrated filter, creating a sharper frequency response roll-off at the edges of the operating bands compared to an antenna with only a basic resonator. The enhanced filtering capability leads the antenna to better reject unwanted interference from adjacent frequency channels.

Another significant advantage is improved radiation coverage. The interaction between the basic resonator 10 and the extended resonator 20 modifies the radiation pattern of the antenna, increasing the gain at large radiation angles. Further, the antenna architecture described herein can be readily implemented using standard printed circuit board (PCB) manufacturing processes or within a semiconductor package, making it suitable for a wide range of integrated wireless devices. Therefore, the antenna in the embodiments provides a broader effective beam width, which enhances signal coverage and link reliability, particularly for mobile applications.

In summary, the embodiment provides a novel antenna architecture that includes a basic resonator and an extended resonator separated by a trench. By designing the coupling between the basic resonator and the extended resonator, the antenna achieves significant performance enhancements. The enhancements include improved out-band radiation suppression, effectively integrating a filtering function into the antenna, and an increased gain at wide radiation angles, which results in a broader effective beam width and enhanced signal coverage. As demonstrated by the various embodiments, the geometric shapes, layered arrangement, and specific structures of via and coupler components can be modified to provide a high degree of adjusting capability over the antenna's frequency response and radiation pattern.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An antenna comprising:
a ground plane;
a basic resonator disposed over the ground plane; and
an extended resonator disposed over the ground plane and separated from the basic resonator by a first trench, wherein the extended resonator comprises:
an extended plate;
a coupler comprising a coupler pad and a ground pad, wherein the coupler pad and the ground pad are capacitively coupled;
at least one extended via electrically connecting the extended plate to the coupler pad; and
at least one ground via electrically connecting the ground pad to the ground plane.

2. The antenna of claim 1, wherein the basic resonator comprises a basic plate, the basic plate is disposed on a same layer as the extended plate, and the basic plate is separated into a plurality of portions by a second trench.

3. The antenna of claim 1, wherein the basic resonator comprises a basic plate having a cutout, the extended resonator is disposed within the cutout, and the first trench is disposed around the extended plate of the extended resonator.

4. The antenna of claim 3, wherein the basic plate is separated into a plurality of portions by a second trench.

5. The antenna of claim 1, wherein the basic resonator comprises a basic plate, the basic plate and the extended plate are disposed on a first layer, and the antenna further comprises a conductive patch disposed on a second layer different from the first layer.

6. The antenna of claim 5, wherein the conductive patch is positioned to at least partially overlap both the basic plate and the extended plate.

7. The antenna of claim 6, wherein the basic plate is separated into a plurality of portions by a second trench.

8. The antenna of claim 6, wherein the second layer is disposed over the first layer or under the first layer.

9. The antenna of claim 1, wherein the extended resonator comprises a plurality of extended vias and a plurality of ground vias.

10. The antenna of claim 1, wherein the basic resonator comprises a basic plate having a cutout, the extended resonator is disposed within the cutout, and the basic plate is disposed on a first layer and the extended plate is disposed on a second layer different from the first layer.

11. The antenna of claim 10, wherein the extended plate at least partially overlaps the basic plate adjacent to the cutout.

12. The antenna of claim 11, wherein the basic plate is separated into a plurality of portions by a second trench.

13. The antenna of claim 1, wherein the at least one extended via comprises a staggered extended via, the staggered extended via comprising:
a first extended via segment;
a second extended via segment horizontally offset from the first extended via segment; and
an extended via pad electrically connecting the first extended via segment and the second extended via segment.

14. The antenna of claim 1, wherein the at least one ground via comprises a staggered ground via, the staggered ground via comprising:
a first ground via segment;
a second ground via segment horizontally offset from the first ground via segment; and
a ground via pad electrically connecting the first ground via segment and the second ground via segment.

15. The antenna of claim 1, wherein a shape of the coupler pad is different from a shape of the ground pad.

16. The antenna of claim 1, wherein the coupler pad comprises at least one first finger, the ground pad comprises at least one second finger, and the at least one first finger is interdigitated with at least one second finger.

17. The antenna of claim 16, wherein a number of the at least one first finger is different from a number of the at least one second finger, and a shape of the coupler pad is different from a shape of the ground pad.

18. The antenna of claim 1, wherein the basic resonator comprises a basic plate having a curved edge, the extended plate has a corresponding curved shape and is disposed adjacent to the curved edge of the basic plate.

19. The antenna of claim 1, wherein the coupler pad is formed of a first conductive material, the ground pad is formed of a second conductive material, and the first conductive material is different from the second conductive material.

20. The antenna of claim 1, wherein the basic resonator comprises a basic plate and a conductive ground wall, and the conductive ground wall is configured to electrically connect the basic plate to the ground plane.
